(19) United States
(12) Patent Application Publication
(10) Pub. No.: US 2023/0078712 A1
(43) Pub. Date: Mar. 16, 2023

(54) SYSTEM AND METHOD FOR PRODUCT PLACEMENT AND EMBEDDED MARKETING

(71) Applicant: Plaiced Inc., Toronto (CA)

(72) Inventors: Kaaveh Shoamanesh, Toronto (CA); Hossein Jalali, Alcabideche (PT)

(21) Appl. No.: 17/942,434

(22) Filed: Sep. 12, 2022

Related U.S. Application Data
(60) Provisional application No. 63/242,839, filed on Sep. 10, 2021.

(51) Int. Cl. G06Q 30/02; G06Q 50/00

(52) U.S. Cl. CPC G06Q 30/0244; G06Q 30/0277; G06Q 50/01; G06Q 30/0276

(57) ABSTRACT

A method for determining one or more publishers for an advertising campaign including receiving an input request comprising a set of metadata from an advertiser device; extracting the set of metadata; generating a plurality of success scores based on the extracted set of metadata using at least one artificial intelligence (AI) or machine learning (ML) algorithm, one or more parameters of the at least one AI or ML algorithm determined via training and testing performed using one or more data sets comprising one or more previous results, and each success score corresponds to one of a plurality of publishers; selecting the one or more publishers from the plurality of publishers based on the one or more success scores; implementing the advertising campaign using the selected publishers; collecting the results of the advertising campaign; and adding the collected results to the one or more previous results.

### CROSS-REFERENCE TO RELATED APPLICATION

This application claims the benefit of and priority to U.S. Provisional Application No. 63/242,839, filed Sep. 10, 2021, which is hereby incorporated by reference herein in its entirety.

### FIELD OF THE INVENTION

The present disclosure relates to product placement, embedded marketing and publisher identification for advertising.

### BRIEF SUMMARY

A system for determining one or more publishers for an advertising campaign comprising a publisher identification subsystem, wherein the publisher identification subsystem is communicatively coupled to an advertiser device and a plurality of publishers via a network, further wherein the publisher identification subsystem comprises a communications subsystem, a database and one or more predictive processing subsystems coupled to each other via an interconnection, the communications subsystem receives one or more incoming signals destined for the publisher identification subsystem, and the communications subsystem transmits one or more outgoing signals originating from the publisher identification subsystem; an input request is received from the advertiser device by the publisher identification subsystem within the one or more incoming signals, wherein the input request comprises a set of metadata; the input request is received by the communications subsystem and sent to the publisher identification subsystem; the set of metadata is extracted by the one or more predictive processing subsystems; the one or more predictive processing subsystems generates a plurality of success scores based on the extracted set of metadata, wherein the plurality of success scores is generated using at least one artificial intelligence (AI) or machine learning (ML) algorithm, one or more parameters of the at least one AI or ML algorithm are determined via training and testing, further wherein the training and testing are performed using one or more data sets comprising one or more previous results, and each of the plurality of success scores corresponds to one of the plurality of publishers; the one or more predictive processing subsystems selects the one or more publishers from the plurality of publishers based on the one or more success scores; the one or more predictive processing subsystems implements the advertising campaign using the selected one or more publishers; and one or more results of the advertising campaign are collected and added to the one or more data sets comprising one or more previous results.

A method for determining one or more publishers for an advertising campaign comprising receiving, by a publisher identification subsystem, an input request comprising a set of metadata, wherein the input request is transmitted by an advertiser device; extracting, by the publisher identification subsystem, the set of metadata; generating, by the publisher identification subsystem, a plurality of success scores based on the extracted set of metadata, wherein the generating is performed using at least one artificial intelligence (AI) or machine learning (ML) algorithm, one or more parameters of the at least one AI or ML algorithm are determined via training and testing, further wherein the training and testing are performed using one or more data sets comprising one or more previous results, and each of the plurality of success scores corresponds to one of the plurality of publishers; selecting, by the publisher identification subsystem, the one or more publishers from a plurality of publishers based on the one or more success scores; implementing, by the publisher identification subsystem, the advertising campaign using the selected one or more publishers; collecting, by the publisher identification subsystem, the results of the advertising campaign; and adding, by the publisher identification subsystem, the collected results of the advertising campaign to the one or more data sets comprising one or more previous results.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings. [insert in final version]

FIG. 1 illustrates an example embodiment of a system for product placement or embedded marketing.

FIG. 2 illustrates an example embodiment of a content creator device.

FIG. 3 illustrates an example embodiment of a product placement subsystem.

FIG. 4 illustrates an example embodiment of a process flow for a product placement deal.

FIG. 5 illustrates an example embodiment of a content owner dashboard.

FIG. 6 illustrates an example embodiment of a content for advertising dashboard.

FIG. 7A illustrates an example embodiment of a deal request form.

FIG. 7B illustrates an example embodiment of a deal negotiating dashboard.

FIG. 7C illustrates an example embodiment of a notes section.

FIG. 8 illustrates an example embodiment of a deal timeline dashboard.

FIG. 9 illustrates an example embodiment of a product and shipping dashboard.

FIG. 10A illustrates an example embodiment of a marketplace dashboard generated for a content creator.

FIG. 10B illustrates an example embodiment of a marketplace dashboard generated for an advertiser.

FIG. 11 illustrates an example embodiment of a search result interface.

FIG. 12 illustrates an example embodiment of a home dashboard.

FIG. 13 illustrates an example embodiment of a publisher identification system.

FIG. 14 illustrates an example embodiment of a publisher identification subsystem.

FIG. 15 illustrates an example embodiment of a process for publisher identification.

FIG. 16 illustrates an example embodiment of an advertiser dashboard.

FIG. 17 illustrates an example embodiment of an advertisement creation interface.

FIG. 18 illustrates an example embodiment of an input request.

FIG. 19 illustrates an example embodiment of a selected publisher interface.

FIG. 20 illustrates an example embodiment of a summary interface.

FIG. 21 illustrates an example embodiment of a payment confirmation window.

FIG. 22 illustrates an example embodiment of a campaign dashboard.

FIG. 23 illustrates an example embodiment of a publisher dashboard.

FIG. 24 illustrates an example embodiment of another publisher dashboard.

FIG. 25 illustrates an example embodiment for the owner of a publisher to view specific campaign related data.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

Product placement is a marketing strategy used by brands to reach target audiences. This placement of branded goods or services is often found in entertainment media, such as in movies, video games, videos uploaded to video platforms such as YOUTUBE®, television or radio. Another term used for product placement is embedded marketing, since the product is embedded in another form of media.

In the past, different systems have been demonstrated for product placement. For example, in United States (US) Patent Application No. 2008/0065508 to Watt et al, filed May 15, 2007 and published on Mar. 13, 2008, a marketplace for brand integration and product placement is detailed. The marketplace enables buyers such as advertisers and agencies to monitor brand integration points as well as a forum to transact with sellers of opportunities for an advertiser to include its brand as part of a given production, such as entertainment providers. This marketplace allows buyers and sellers to determine where to make offers and interact in such a way as to obtain different deals. However, US Patent Application No. 2008/0065508 does not disclose details of deal progress or deal timelines for an advertiser or content creator.

In US Patent Application Publication No. 2017/0013309 to Jallouli, filed Jul. 15, 2016 and published on Jan. 12, 2017, a product placement system implemented using cloud computing resources and relating to product placement in video content was disclosed. This system offers consumers opportunities to discover and buy products which have been placed in video content. However it does not provide content creators and brand managers with a marketplace to interact so as to place products within content.

US Patent Application Publication No. 2021/0211779 to Wu et al, filed Mar. 22, 2021 and published on Jul. 8, 2021, discloses systems for flexible product placement to allow adaptive marketing targeted at different demographics. However, this work also does not provide content creators and brand managers with a marketplace to interact.

Product placement is one way for brands and advertisers to reach target audiences. In addition to product placement, brands and advertisers also try to reach target audiences via third party publishing platforms or publishers. Examples of third-party publishing platforms or publishers include:
online communities, such as those formed on
   online forums such as REDDIT® and DISCORD®,
   social media networks such as FACEBOOK®, and
   instant messaging applications such as SLACK® and WHATSAPP®;
parties which publish content; and
Web3 sites which publish content.

In order for brands and advertisers to optimally use their budgets, it is useful for brands and advertisers to determining the best publishers to reach target audiences. Many prior art systems focus on determining publishers by determining which publishers receive the most attention from a target audience through, for example, determining an attention score. Other prior art systems focus on identifying publishers by determining which publishers a certain target audience engages with the most through, for example, determining an engagement score. However, attention-based and engagement-based techniques are indirect measures of advertiser success, since they do not measure whether advertisers or brands are actually succeeding in converting advertising spending into revenue by targeting certain publishers.

Systems and methods which overcome the above shortcomings in prior art product placement and prior art publisher determination systems are described below.

To overcome the shortcomings of prior art product placement systems, various embodiments of a system and method to provide both content creators and advertisers with an online marketplace via a website are described below. The online marketplace comprises dashboards and interfaces so as to enable content creators and advertisers to interact with each other so as to complete, track and manage product placement deals. Furthermore, it provides the content creators and advertisers with search functionalities to ensure correct matching and targeting. Finally, through the use of machine learning (ML) and artificial intelligence (AI), the system and method described below provides insights into the compatibility of content creators and advertisers with each other.

By using the system and method detailed below, content creators and advertisers reduce the friction of trying to find opportunities and appropriate brands for placement. The dashboards and interfaces presented below provide both content creators and advertisers with simple, easy “one-stop” shopping experiences, thereby increasing efficiency and reducing wasted time and energy. Furthermore, the use of web-based and other technologies such as search technologies, database and payment technologies offer easier retrieval, presentation and customization of information for content creators and advertisers. Furthermore, important information such as timelines can be presented. This data can then be exported to electronic devices or filtered for presentation as necessary. Furthermore, as new content or brands are added, both content creators and advertisers can view these new entries immediately. All of these advantages lead to either improved revenues or reduced costs for content creators and advertisers.

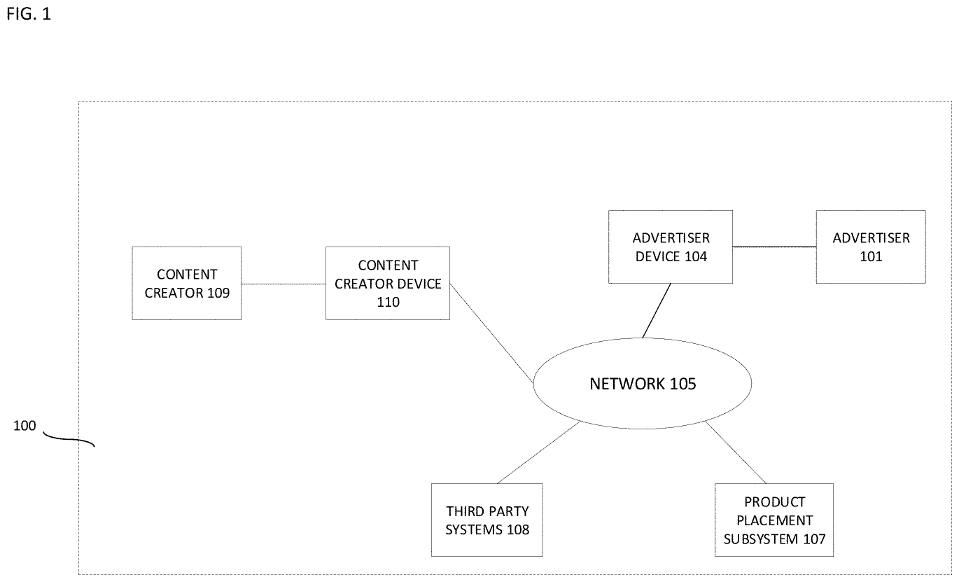

FIG. 1 shows an example system 100. There are two types of users: content creators and advertisers. Content creator 109 is associated with content creator device 110. Content creator 109 is, for example, a person responsible for the creation of content such as video or audio media. Content creator 109 is, for example a person from a production company, an entertainment network, a film production house, a music video company, a video game producer or a person creating videos for a hosted video platform such as TIKTOK® or YOUTUBE®. Content creator 109 is seeking out brands to place within content.

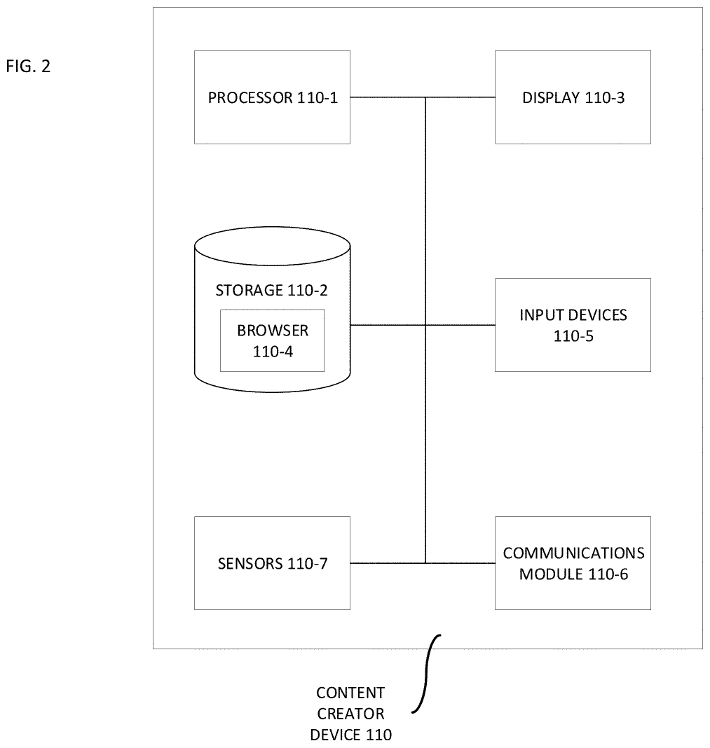

Content creator device 110 is, for example, a laptop, desktop, server, smartphone, tablet or an appropriate computing and network-enabled device. An example embodiment of content creator device 110 is shown in FIG. 2. In FIG. 2, processor 110-1 performs processing functions and operations necessary for the operation of content creator device 110, using data and programs stored in storage 110-2. An example of such a program is browser 110-4. Display 110-3 performs the function of displaying data and information for user 101. Input devices 110-5 allow one of the development users 101 to enter information. This includes, for example, devices such as a touch screen, mouse, keypad, keyboard, microphone, camera, video camera and so on. In some embodiments, display 110-3 is a touchscreen which means it is also part of input devices 110-5. Communications module 110-6 allows user device 110 to communicate with devices and networks external to user device 110. This includes, for example, communications via BLUETOOTH®, Wi-Fi, Near Field Communications (NFC), Radio Frequency Identification (RFID), 3G, Long Term Evolution (LTE), Universal Serial Bus (USB) and other protocols known to those of skill in the art. Sensors 110-7 perform functions to sense or detect environmental or locational parameters. Sensors 110-7 include, for example, accelerometers, gyroscopes, magnetometers, barometers, Global Positioning System (GPS), proximity sensors and ambient light sensors. The components of content creator device 110 are coupled to each other as shown in FIG. 2.

Browser 110-4 allows a content creator 109 to interact with a product placement subsystem 107 via network 105. A marketplace website is presented to the content creator 109 via browser 110-4. The content creator 109 can then interact with the presented website using, for example, input devices 110-5.

One of skill in the art would know that a browser is not the only way for the content creator 109 to interact with the product placement subsystem 107. In some embodiments, content creator 109 interacts with product placement subsystem 107 via an application such as a desktop application or a mobile application.

Advertiser 101 is associated with advertiser device 104. Advertiser 101 is, for example, a company seeking opportunities to advertise a brand, an advertising agency, or a media buyer working on behalf of a company seeking opportunities to advertise a brand. Advertiser device 104 is, for example, a laptop, desktop, server, smartphone, tablet or any appropriate computing and network-enabled device. In some embodiments, the structure of advertiser device 104 is similar to the structure of content creator device 110 as shown in FIG. 2. Then similar to the content creator 109, advertiser 101 interacts with product placement subsystem 107 via a browser on advertiser device 104 accessing a website, or via an application running on advertiser device 104.

Networks 105 plays the role of communicatively coupling the various components of system 100. Networks 105 can be implemented using a variety of networking and communications technologies. In some embodiments, networks 105 are implemented using wired technologies such as Firewire, Universal Serial Bus (USB), Ethernet and optical networks. In some embodiments, networks 105 are implemented using wireless technologies such as WiFi, BLUETOOTH®, NFC, 3G, LTE and 5G. In some embodiments, networks 105 are implemented using satellite communications links. In some embodiments, the communication technologies stated above include, for example, technologies related to a local area network (LAN), a campus area network (CAN) or a metropolitan area network (MAN). In yet other embodiments, networks 105 are implemented using terrestrial communications links. In some embodiments, networks 105 comprise at least one public network. In some embodiments, networks 105 comprise at least one private network. In some embodiments, networks 105 comprise one or more subnetworks. In some of these embodiments, some of the subnetworks are private. In some of these embodiments, some of the subnetworks are public. In some embodiments, communications within networks 105 are encrypted.

Product placement subsystem 107 is used for a variety of purposes. This includes, for example:
Storing and analyzing data such as content and brands for content creators and advertisers to access;
Generating one or more interfaces and dashboards using the stored data and the data analysis, as will be further described below;
Providing search functionalities for content creators and advertisers to find opportunities;
Performing functions necessary for the operation of the marketplace in conjunction with third party systems where necessary; and
Implementation of web server and other data functionalities for the marketplace website, such as searching, exporting and filtering data.

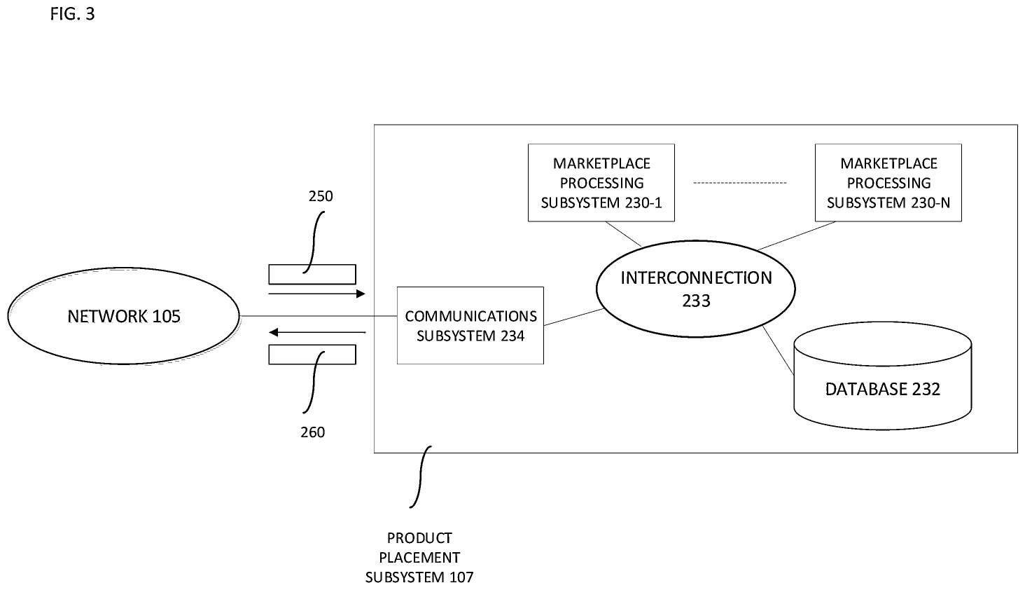

A detailed embodiment of product placement subsystem 107 is shown in FIG. 3. Communications subsystem 234 is coupled to network 105. Communications subsystem 234 receives information from, and transmits information to network 105. Communications subsystem 234 can communicate using the communications and networking protocols and techniques that network 105 utilizes. Communications subsystem 234 receives information from network 105 within, for example, incoming signals 250; and transmits information to network 105 within, for example, outgoing signals 260. Incoming signals 250 comprise, for example, data and commands transmitted by either content creator device 110 or advertiser device 104. Outgoing signals 260 comprise, for example, data associated with dashboards, interfaces, search results and other information generated and transmitted by product placement subsystem 107 to, for example, content creator device 110 or advertiser device 104.

Databases 232 stores information and data for use by product placement subsystem 107. This includes, for example:
one or more algorithms and programs necessary to perform validation, and
data needed for the marketplace processing subsystems 230-1 to 230-N to perform operations and functions. This comprises, for example:
   user profiles,
   payment information,
   previous deals connected with each user,
   timelines of previous deals,
   search histories,
   previous search results, and
   product and shipping information.

In some embodiments, database 232 further comprises a database server. The database server receives one or more commands from, for example, validation processing subsystem 230-1 to 230-N and communication subsystem 234, and translates these commands into appropriate database language commands to retrieve and store data into databases 232. In one embodiment, database 232 is implemented using one or more database languages known to those of skill in the art, including, for example, Structured Query Language (SQL). In a further embodiment, database 232 stores data for a plurality of content creators and advertisers. Then, there may be a need to keep the set of data related to each content creator or advertiser separate from the data relating to the other content creators or advertisers. In some embodiments, databases 232 is partitioned so that data related to each content creator or advertiser is separate from the other content creators or advertisers. Then each content creator or advertiser needs to authenticate themselves so as to access information related to their particular data sets. In a further embodiment, when data is entered into databases 232, associated metadata is added so as to make it more easily searchable. In a further embodiment, the associated metadata comprises one or more tags. In yet another embodiment, database 232 presents an interface to enable the entering of search queries. Further details of this are explained below. In some embodiments databases 232 comprises a transactional database. In other embodiments, databases 232 comprise a multitenant database.

Interconnection 233 connects the various components of product placement subsystem 107 to each other. In some embodiments, interconnection 233 is implemented using, for example, network technologies known to those in the art. These include, for example, wireless networks, wired networks, Ethernet networks, local area networks, metropolitan area networks and optical networks. In some embodiments, interconnection 233 comprises one or more subnetworks. In another embodiment, interconnection 233 comprises other technologies to connect multiple components to each other including, for example, buses, coaxial cables, USB connections and so on.

Marketplace processing subsystem 230-1 to 230-N perform processing and analysis within product placement subsystem 107 using one or more algorithms and programs. These algorithms and programs are stored in, for example:
database 232 as explained above, or
within marketplace processing subsystems 230-1 to 230-N.

Examples of operations performed by marketplace processing subsystem 230-1 to 230-N comprise:
Processing of commands sent by, for example, content creator device 110 or advertiser device 104. In some embodiments, the processing of commands is performed using data stored in database 232;
Implementation of web server functionalities for the marketplace website comprising, for example, generating and transmitting dashboards and interfaces, as will be described below, to content creator device 110 or advertiser device 104 via communications subsystems 234 and network 105, using, for example data stored in database 232;
Communicating with third party systems 108 where necessary to perform operations necessary to ensure smooth running of the marketplace;
Performance of AI and ML-related operations such as:
   pre-processing of data sets prior to performing AI or ML operations such as training and testing,
   model training using training data sets,
   model testing using testing data sets,
   selecting appropriate models to use,
   performance evaluation of different AI or ML models, and
   post-processing of data sets;
In some embodiments, performing functions necessary to enable searching of database 232 such as implementation of appropriate data search algorithms; and
Communicating with third party systems to enable fulfilment of functions.

Various implementations are possible for product placement subsystem 107 and its components. In some embodiments, product placement subsystem 107 is implemented using a cloud-based approach. In other embodiments, product placement subsystem 107 is implemented across one or more facilities, where each of the components are located in different facilities and interconnection 233 is then a network-based connection. In further embodiments, product placement subsystem 107 is implemented within a single server or computer. In yet other embodiments, product placement subsystem 107 is implemented in software. In other embodiments, product placement subsystem 107 is implemented using a combination of software and hardware. In yet other embodiments, product placement subsystem 107 is hosted by a cloud services provider such as AMAZON® Web Services.

Third party systems 108 are systems owned by third party providers. These include, for example, systems to:
Track shipments of products,
Fulfil payments,
Enable live chats, and
Enable social media interaction.

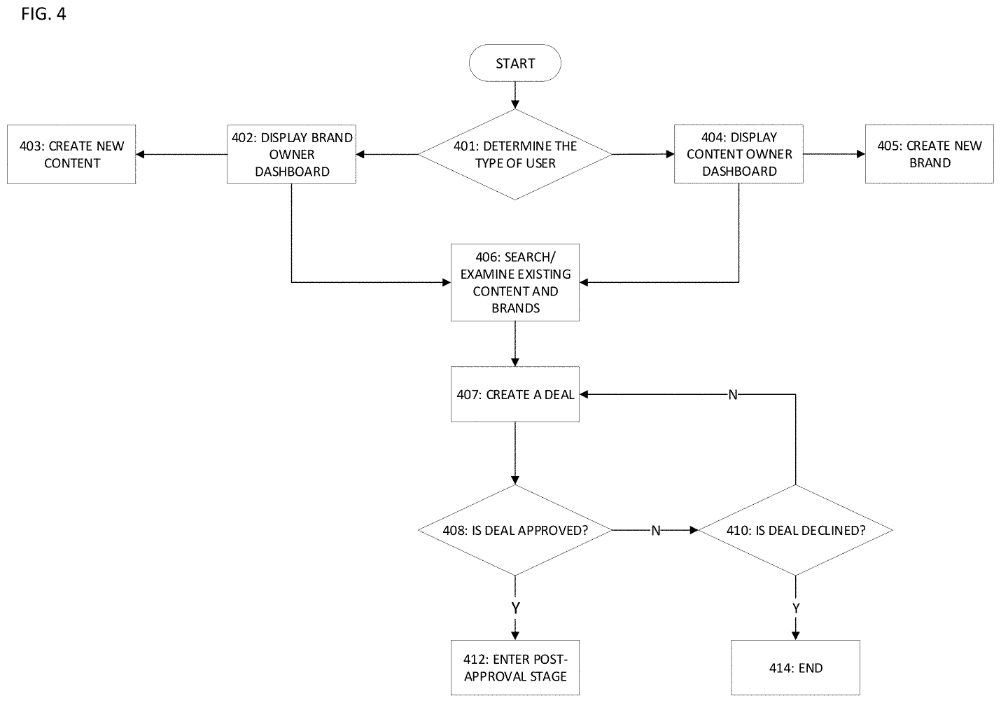

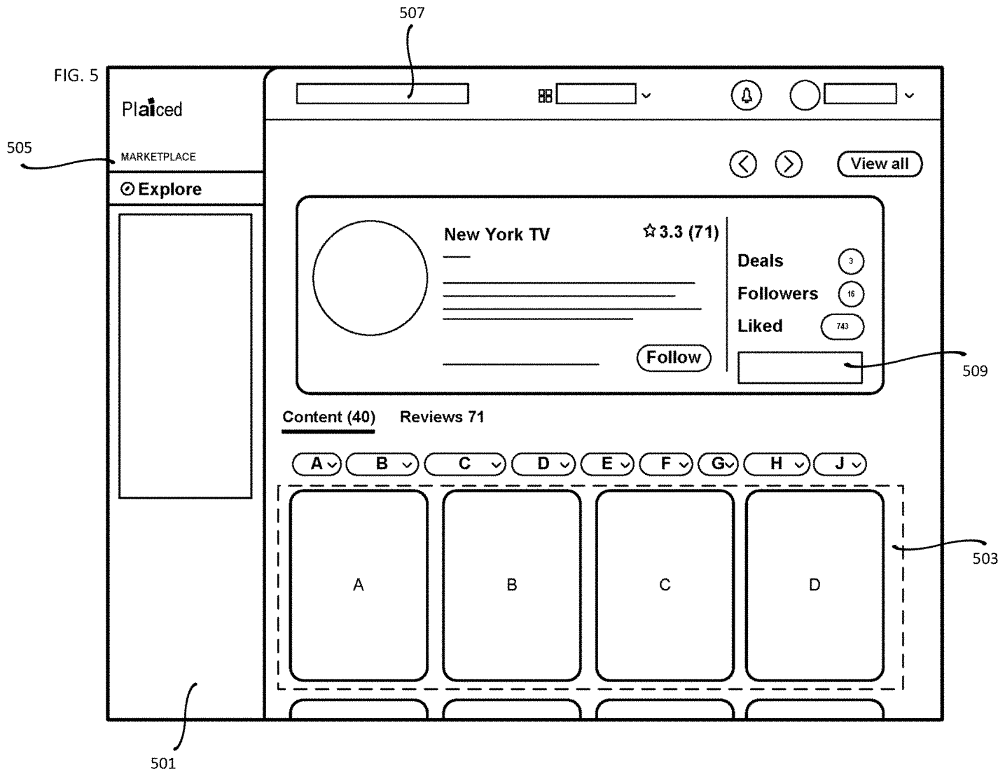

An example process for the operation of the marketplace is illustrated in FIG. 4 and with reference to FIGS. 1 — 3 and the dashboards and interfaces presented in FIGS. 5-12. These dashboards and interfaces are presented to the content creator 109 and advertiser 101 via browser programs running on content creator device 110 and advertiser 104 respectively.

In FIG. 4, in step 401, after the user authenticates themselves via one or more techniques known to those of skill in the art from content creator device 110 or advertiser device 104, the type of user is determined, that is, whether it is a content creator or an advertiser.

When it is determined in step 401 that the type of user is an advertiser 101 utilizing advertiser device 104, then in step 404 a content owner dashboard is generated by one or more of marketplace processing subsystems 230-1 to 230-N, using, for example, data and algorithms stored in database 232. FIG. 5 shows an example embodiment of content owner dashboard 501. Content owner dashboard 501 comprises content 503, marketplace link 505, search space 507 and social media button 509. These components will be explained in further detail below. The content owner dashboard 501 is transmitted to advertiser device 104 via communications subsystem 234 and networks 105, where it is displayed. The content owner dashboard then allows for an advertiser 101 to search for opportunities for product placement in a more efficient and cost-effective way.

The advertiser can create new brands in step 405.

In step 406, in some embodiments, the advertiser 101 searches for existing content owned by a content owner. In some embodiments, the advertiser 101 uses content owner dashboard 501 to search for existing content owned by a content owner. For example, the advertiser 101 uses content owner dashboard 501 to send commands to product placement subsystem 107 to search previously created content using, for example, the search engine in database 232 or marketplace processing subsystems 230-1 to 230-N as described above.

In some embodiments, the advertiser 101 uses content owner dashboard 501 to examine content owned by a content owner and presented in dashboard 501 in step 406. For example, in dashboard 501, advertiser 104 can examine content owned by New York TV in dashboard 501. When the advertiser 104 wants to initiate a deal, the advertiser clicks on the content such as content 503 within content owner dashboard 501.

When it is determined that the type of user is a content creator 109 utilizing content creator device 110, then in step 402, a brand owner dashboard similar to the content owner dashboard 501 is generated by one or more of marketplace processing subsystems 230-1 to 230-N, using, for example, data and algorithms stored in database 232. This brand owner dashboard is then transmitted to content creator device 110 via, for example, communications subsystem 234 and network 105. The brand owner dashboard allows the content creator 109 to search for brands for placement.

The content creator 109 can create new content in step 403.

Similar to as described above for the content owner dashboard 501, the content creator 109 can use the brand owner dashboard to search for existing brands owned by a brand owner, or examine brands owned by a brand owner in step 406. When a content creator 109 wants to initiate a deal, the content creator can click on a brand within the brand owner dashboard.

When the advertiser 104 or content creator 109 wants to create a new deal by clicking on either content or a brand within the appropriate dashboard, the process moves to step 407. Then, a new dashboard is generated and transmitted for display. For example, when the advertiser 101 clicks on content in content owner dashboard 501, then content for advertising dashboard 601 is generated by marketplace processing subsystems 230-1 to 230-N and transmitted to advertiser device 104.

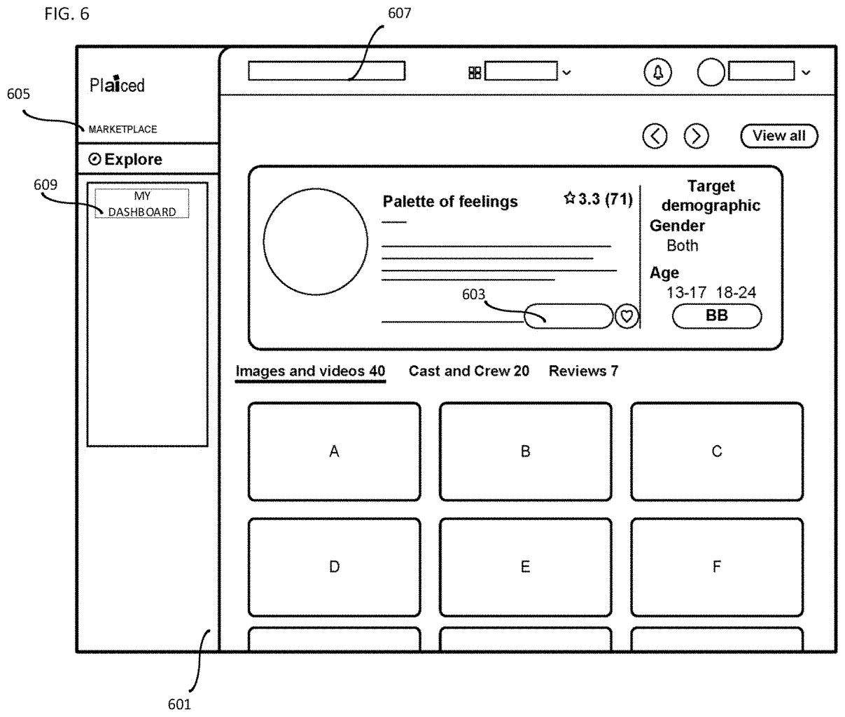

An example of content for advertising dashboard 601 is shown in FIG. 6. This shows, for example,
target demographics of the content consumers,
an overview of the content,
media associated with the content, and
reviews of the content, and
a request deal button 603 for the advertiser 101 to send a request to create a deal.

Additionally, dashboard 601 comprises marketplace link 605, search space 607, and “My Dashboard” link 609. These will be explained in further detail below.

Similarly, a content creator 109 can initiate a deal by clicking on a brand in a brand owner dashboard. Then a brand for placement dashboard is generated by marketplace processing subsystems 230-1 to 230-N and transmitted to content creator device 110.

When an advertiser 101 wishes to send a request to create a deal for placement in content in step 407, the advertiser 101 interacts with the content for advertising dashboard 601, for example, by clicking the request deal button 603 in content for advertising dashboard 601. A request is generated and transmitted to product placement subsystem 107 from advertiser device 104 via network 105 and communications subsystem 234.

A deal negotiating dashboard comprising the deal terms is then created by, for example, marketplace processing subsystem 230-1 to 230-N using data and information stored in database 232. In some embodiments, key information comprising the deal terms is retrieved from the advertiser 101 profile in database 232 and included in the deal negotiating dashboard so as to reduce the effort of entering deal terms every time. Examples of deal terms comprise what the advertiser wants to provide and what benefits the advertiser would like for exposure. In other embodiments, the advertiser is provided with an option to merely enter that they are flexible. The deal negotiating dashboard is then transmitted to content creator device 109 via communications subsystem 234 and networks 105. Similarly, a content creator 109 can send a request to create a deal.

To send a deal request, either party can send a deal request form. The deal request form is generated by marketplace processing subsystem 230-1 to 230-N. While the process flow described below is for the case when an advertiser 101 sends a request to create a deal, one of skill in the art would understand that an analogous process flow to the one above is performed when the content creator 109 sends a request to create a deal.

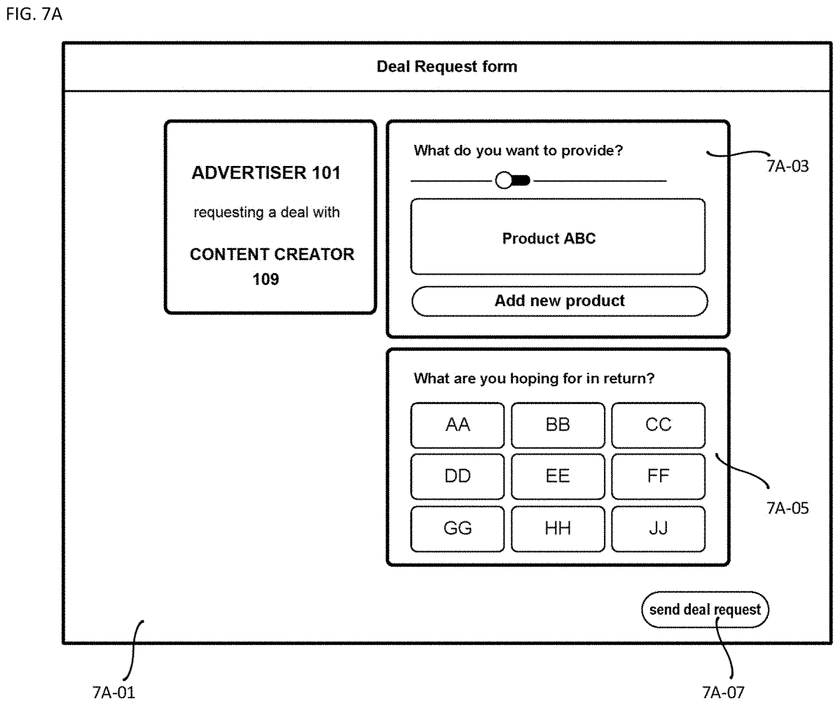

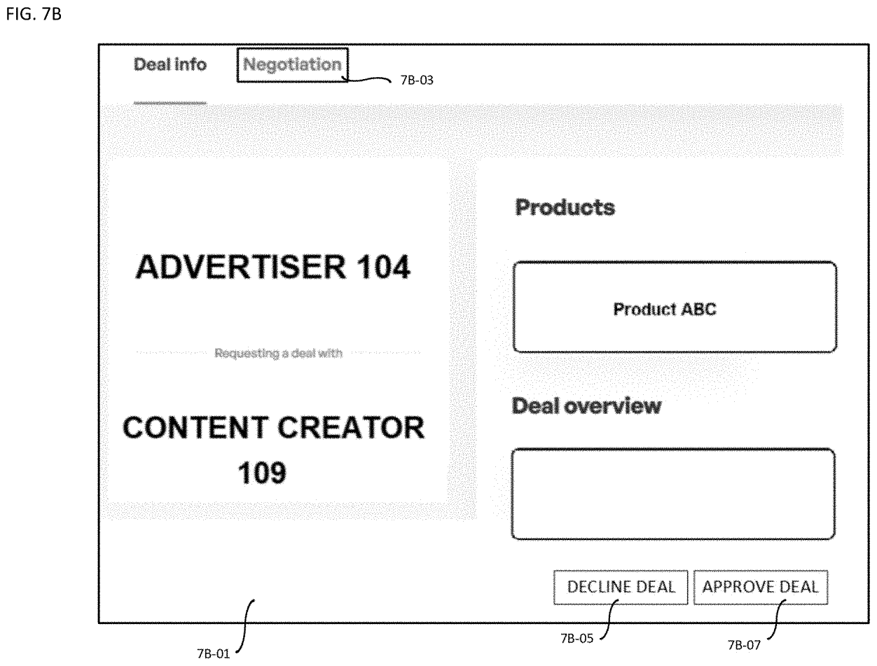

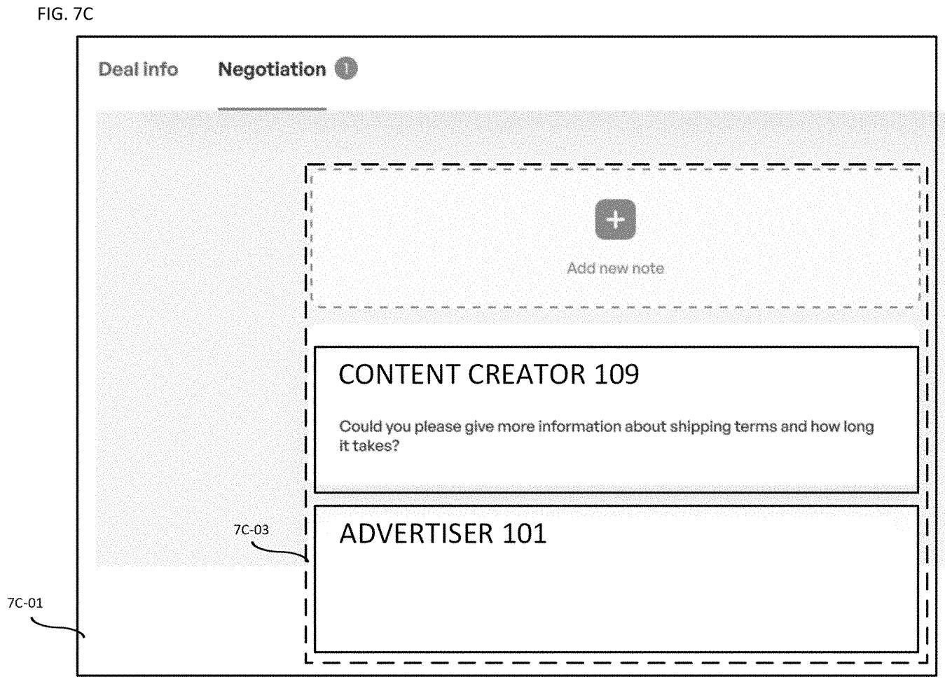

An example embodiment of a deal request form 7A-01 is shown in FIG. 7A. Deal request form 7A-01 allows an advertiser 101 to specify terms, for example, what the advertiser will provide in field 7A-03; and what the advertiser hopes for in return in field 7A-05 for placement of the brand. The advertiser 101 clicks on the deal request button 7A-07 to send a deal request.

A deal negotiating dashboard would be generated in a similar fashion to that described above, and transmitted to the content creator device 110 for content creator 109 to view and interact with. An example is shown in FIG. 7B. The deal negotiating dashboard 7B-01 is populated with information such as deal terms for approval such as exposure and requested benefits. In other embodiments, the deal negotiating dashboard 7B-01 comprises information such as:
other deals that have been approved for other products,
products that are being shipped, and
any notes or comments that the advertiser or content creator may have.

In some embodiments, compatibility insights are provided using, for example, AI or ML approaches within step 407. These insights are generated based on, for example, training and testing using historical data.

The deal negotiating dashboard 7B-01 presents the content creator 109 with options of either approving the deal, negotiating the deal or declining the deal. When the content creator 109 opts to negotiate the deal, that is, continue to discuss and refine terms with the content creator 109 (step 410) by clicking on the negotiation button 7B-03 in dashboard 701, a signal indicative of this decision is transmitted to marketplace processing subsystems 230-1 to 230-N. A notes section is generated and transmitted to the content creator device 110 by, for example, marketplace processing subsystems 230-1 to 230-N. The content creator 109 can then enter comments and notes in this section from device 110.

An example notes section 7C-01 is shown in FIG. 7C. Section 7C-03 allows for either advertiser 101 or content creator 109 to add new comments and read previously inserted comments or notes.

When the content creator 109 wants to decline the deal, the content creator 109 opts in step 407 to decline the deal by clicking on the decline deal button 7B-05 (step 410). A signal indicative of this decision is transmitted to marketplace processing subsystems 230-1 to 230-N. This brings the process to an end (step 414).

When the content creator 109 approves the deal by, for example, clicking the approve deal button 7B-07 in dashboard 701, (step 408) then a signal indicative of this decision is transmitted to marketplace processing subsystems 230-1 to 230-N, and the process moves to step 412.

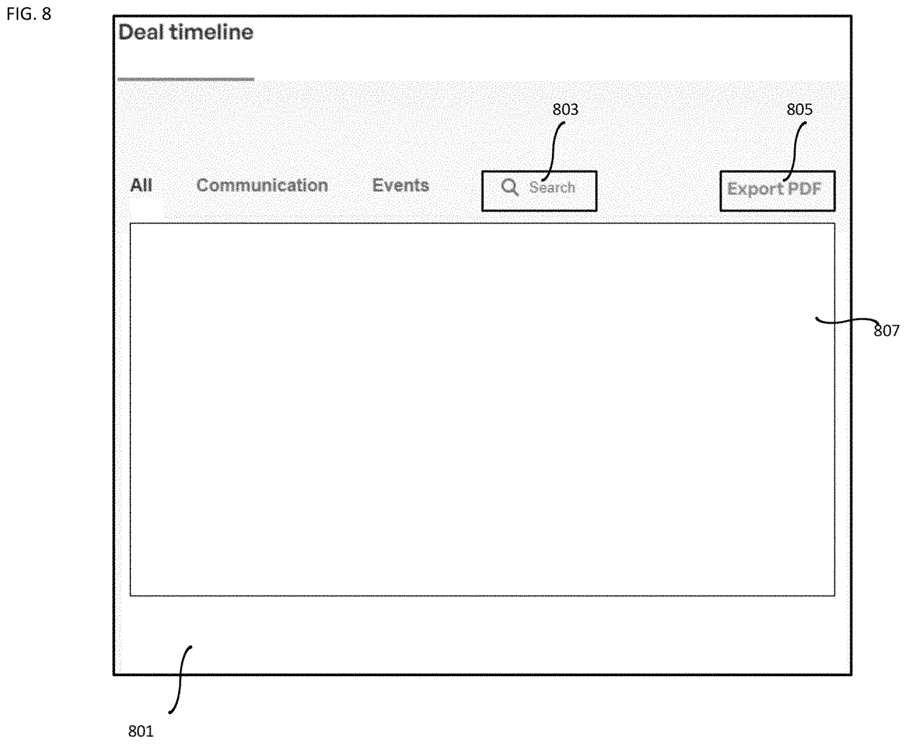

In step 412, the process enters the post-approval stage. As part of step 412, a deal timeline dashboard is generated for transmission and display on device 110. An example deal timeline dashboard 801 is shown in FIG. 8. The dashboard 801 is created by, for example, marketplace processing subsystem 230-1 to 230-N using data and information stored in database 232; and transmitted to content creator device 110 via communications subsystem 234 and networks 105. The content creator 109 can then view the generated dashboard 801 on display 110-3.

Deal timeline dashboard 801 shows, for example, a timeline of a deal made with a particular advertiser 101. The timeline comprises a chronological record of various events in the deal such as in section 807, and is stored in, for example, database 232. The content creator 109 can perform various functions on the timeline from dashboard 801.

In some embodiments, the content creator 109 searches the timeline, by clicking a button such as a search button 803 on dashboard 801. A command is then sent to either the search engine on database 232 or the marketplace processing subsystems 230-1 to 230-N to search the timeline. In other embodiments, the content creator 109 exports the timeline to device 110 by clicking on an export button such as export button 805. A command is sent which causes the marketplace processing subsystems 230-1 to 230-N to transmit the timeline data to content creator device 110 via, for example, communications subsystem 234 and networks 105. In yet other embodiments, the content creator 109 filters the timeline by clicking on a button on dashboard 801. This causes the marketplace processing subsystems 230-1 to 230-N to perform filtering operations on the timeline such as providing events after or before a certain point in time, and transmit the results to content creator device 110.

In step 412, as part of the post-approval stage, the content creator 109 pays the advertiser 101. This is performed using, for example, a credit card or other payment information stored on database 232 or by using a third-party system 108 such as a financial institution or other payment system.

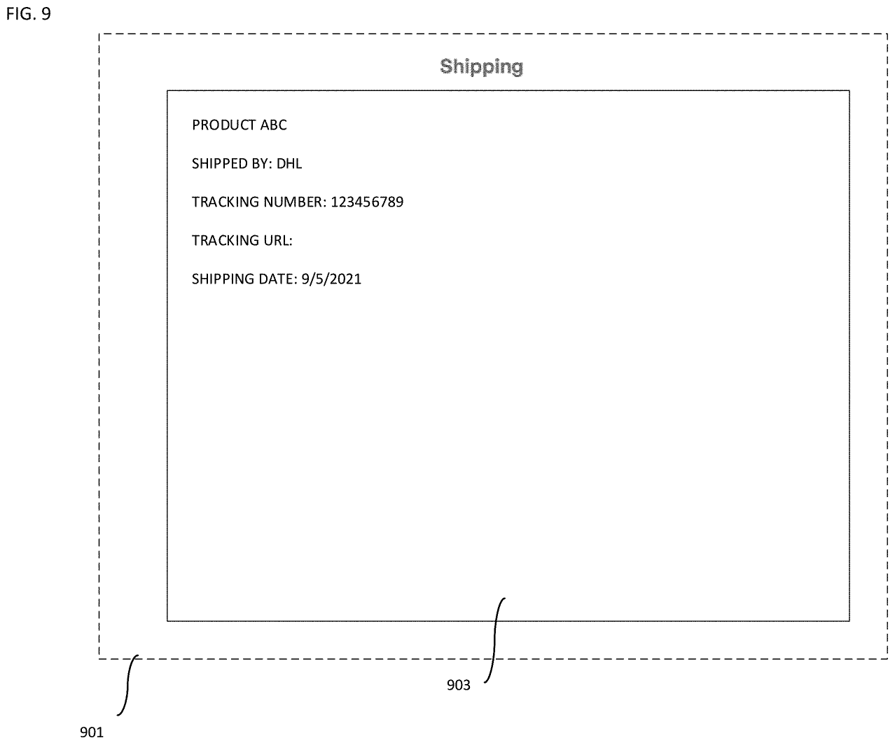

The content creator 109 and the advertiser 101 can view the different products and their shipping status via a product and shipping dashboard. An example product and shipping dashboard 901 is shown in FIG. 9. Product and shipping dashboard 901 comprises, for example, different products which have been ordered and their shipping status. The dashboard 901 is created by, for example, marketplace processing subsystem 230-1 to 230-N using data and information stored in database 232. In some embodiments, dashboard 901 is created using information supplied by one of third party systems 108. Dashboard 901 is then transmitted to content creator device 110 via communications subsystem 234 and networks 105. The content creator 109 can then view the generated dashboard 901 on display 110-3.

When either of the content creator 109 or advertiser 101 clicks on a link or button such as the marketplace link 505 in FIG. 5 or 605 in FIG. 6, then the marketplace processing subsystem 230-1 to 230-N will generate a marketplace dashboard and transmit this to either content creator device 110 or advertiser device 104.

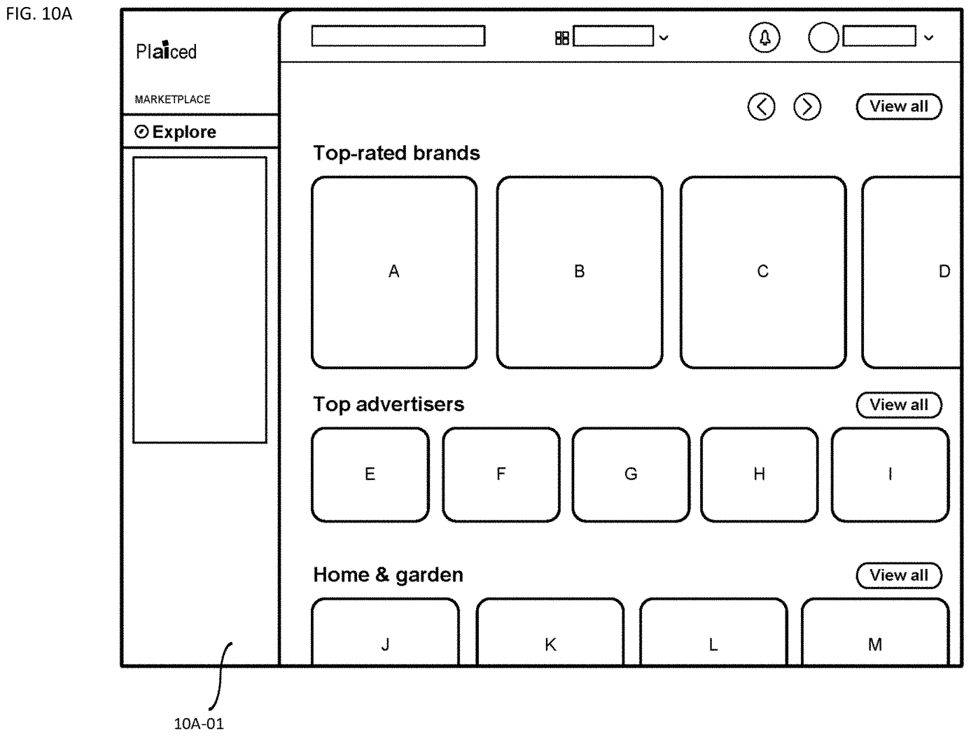

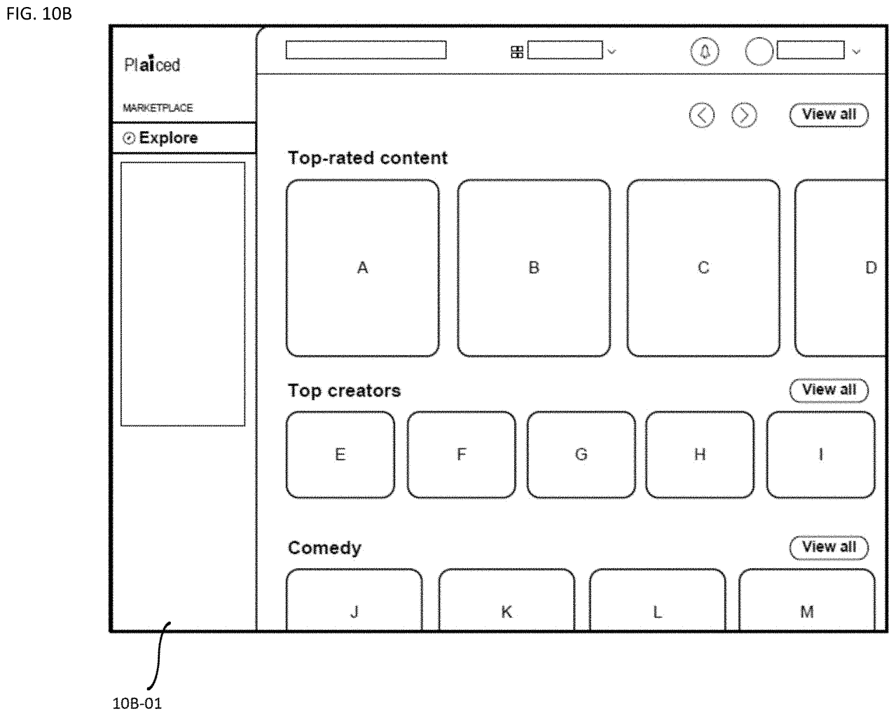

An example embodiment of a marketplace dashboard is dashboard 10A-01 generated for a content creator 109 and shown in FIG. 10A. Content creator 109 sees, for example, top-rated brands and top advertisers.

Another example embodiment of a marketplace dashboard is dashboard 10B-01 generated for advertiser 101 and shown in FIG. 10B. Dashboard 10B-01 enables advertiser 101 to see, for example, top-rated content, top content creators, and content including content organized into genres such as comedy.

In some embodiments, there is also a general search functionality provided to either content creator 109 or advertiser 101. An example is shown in FIGS. 5 and 6, where a search space 507 and 607 respectively are provided.

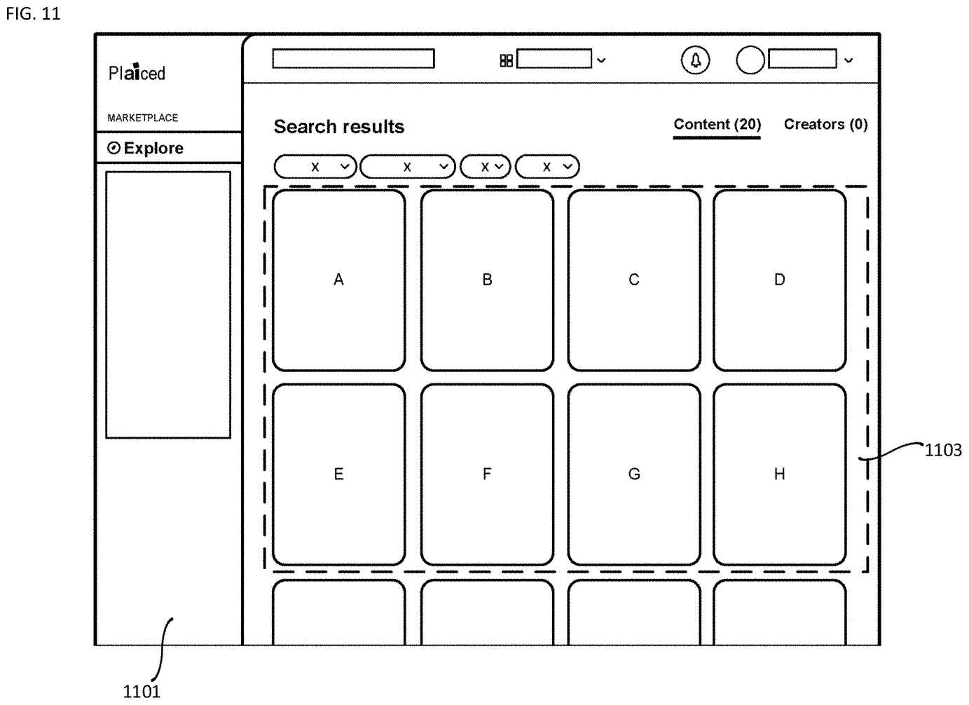

Then, when a content creator 109 or advertiser 101 inputs one or more search terms in a search space such as search space 507 in FIG. 5 or search space 607 in FIG. 6, the terms are communicated to product placement subsystem 107 via, for example, network 105 and communications subsystem 234 using protocols known to those of skill in the art. The search operation is performed using, for example, marketplace processing subsystems 230-1 to 230-N or the search engine within database 232. A search result interface comprising the results of the search operation is transmitted to either content creator device 110 or advertiser device 104. An example embodiment of a search result interface 1101 with search results 1103 is shown in FIG. 11.

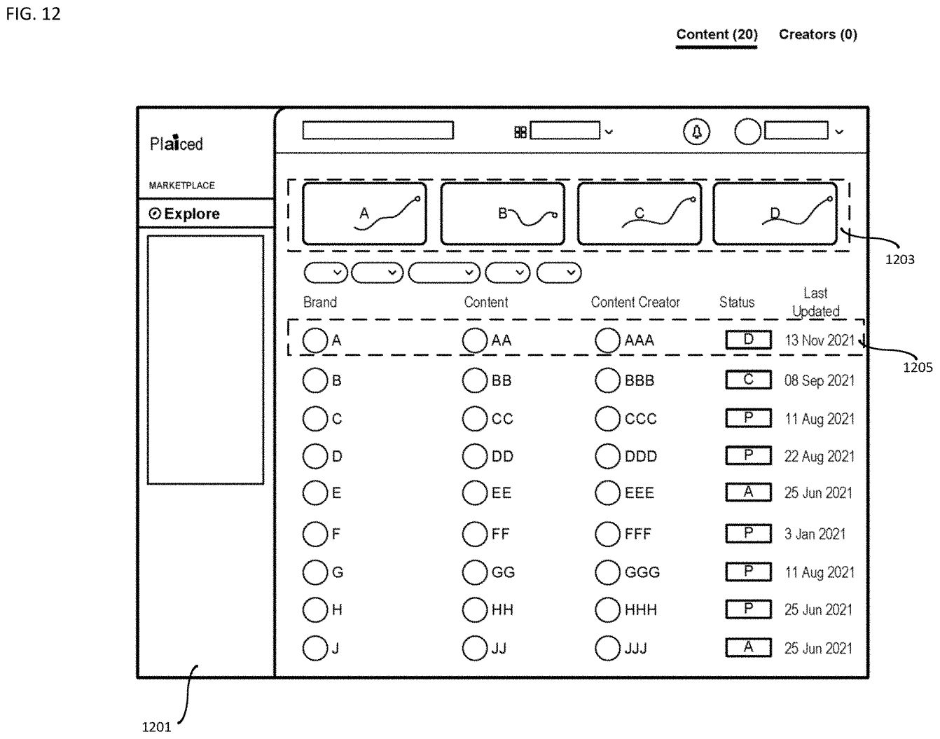

When either of the content creator 109 or advertiser 101 clicks on a “My Dashboard” link such as link 609 in dashboard 601, then the marketplace processing subsystem 230-1 to 230-N will generate a home dashboard and transmit this to either content creator device 110 or advertiser device 104. An example of a home dashboard 1201 is shown in FIG. 12. Dashboard 1201 is generated for advertiser 101. The advertiser 101 can view in, for example, element 1203 of dashboard 1201 which deals are pending, which deals are active, which deals are closed and total deals. Furthermore, the advertiser 101 can view the deals for each brand including the content, content creator and status, such as shown in element 1205.

In some embodiments, the content creator 109 or advertiser 101 wishes to interact with social media to, for example, share content. Then they can do so from at least one of the above-presented dashboards and interfaces. An example of a button to enable social media functionality is, for example, button 509 in dashboard 501 of FIG. 5.

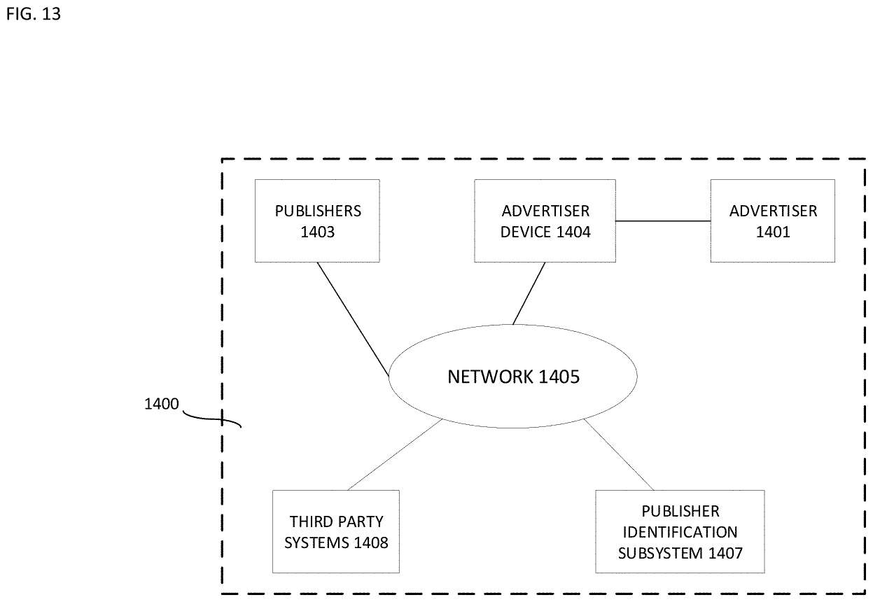

Embodiments of a system and method which overcome the previously described shortcomings of prior art publisher determination systems are described below. FIG. 13 shows an example embodiment. In FIG. 13, advertiser 1401 is associated with advertiser device 1404. Advertiser device 1404 is coupled to publisher identification subsystem 1407, and third-party systems 1408 via network 1405. Advertiser device 1404 is similar to, for example, advertiser device 104. Network 1405 is similar to network 105. Publishers 1403 are coupled to publisher identification subsystem 1407 via network 1405.

Advertisers 1401 and publishers 1403 have been described previously above.

Publisher identification subsystem 1407 is used for a variety of purposes. This includes, for example:
Storing and analyzing data including but not limited to data related to publishers and campaigns such as campaign successes;
Generating one or more interfaces and dashboards using the stored data and the data analysis, as will be further described below;
Providing search functionalities for advertisers to select publishers;
Performing functions necessary for the operation of the marketplace in conjunction with third party systems where necessary;
Implementation of AI and ML-related operations as will be explained below; and
Implementation of an offer bot as will be explained below.

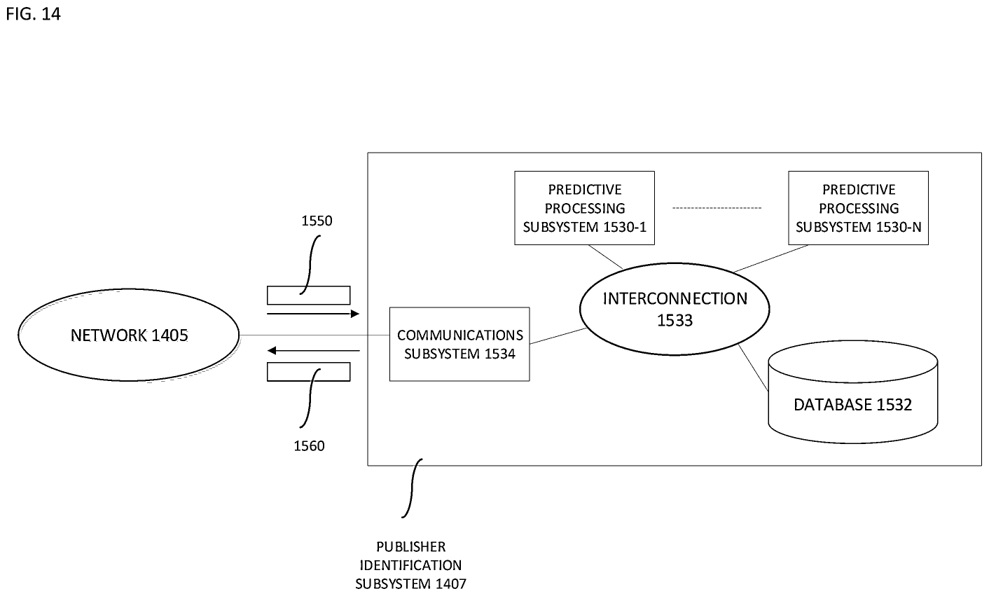

A detailed embodiment of publisher identification subsystem 1407 is shown in FIG. 14. Publisher identification subsystem 1407 comprises communications subsystem 1534, predictive processing subsystems 1530-1 to 1530-N, interconnection 1533 and database 1532.

Communication subsystem 1534 is similar to communications subsystem 234 of FIG. 3. Communication subsystem 1534 is coupled to network 1405 to receive information from, and transmit information to network 1405. Communications subsystem 1534 receives information from network 1405 within, for example, incoming signals 1550; and transmits information to network 1405 within, for example, outgoing signals 1560. Incoming signals 1550 comprise, for example, data and commands transmitted by advertiser device 1404 such as input requests and metadata. Outgoing signals 1560 comprise, for example, data associated with dashboards, interfaces, search results and other information generated and transmitted by publisher identification subsystem 1407 to advertiser device 1404.

Interconnection 1533 is similar to interconnection 233. Interconnection 1533 communicatively couples the various components of publisher identification subsystem 1407 to each other. Similar to interconnection 233, interconnection 1533 is implemented using, for example, network technologies known to those in the art.

Predictive processing subsystems 1530-1 to 1530-N perform the functionalities necessary to identify publishers through the use of AI/ML within publisher identification subsystem 1407 using one or more programs. These algorithms and programs are stored in, for example:
database 1532, or
within predictive processing subsystems 1530-1 to 1530-N.

Examples of operations performed by predictive processing subsystems 1530-1 to 1530-N comprise:
Processing of commands sent by, for example, advertiser device 1404 or publishers 1403. In some embodiments, the processing of commands is performed using data stored in database 1532;
Performance of AI and ML-related operations such as:
   pre-processing of data sets prior to performing AI or ML operations such as training and testing,
   model training using training data sets,
   model testing using testing data sets,
   selecting appropriate models to use,
   performance evaluation of different AI or ML models, and
   post-processing of data sets;
In some embodiments, performing functions necessary to enable searching of database 1532 such as implementation of appropriate data search algorithms;
Implementation of an advertising or offer bot, which will be discussed in further detail below. This comprises, for example, generation of dashboards and interfaces based on data received from advertiser device 1404 and data stored in databases 1532; and
Communicating with third party systems to enable fulfilment of functions.

Various implementations are possible for publisher identification subsystem 1407 and its components. In some embodiments, publisher identification subsystem 1407 is implemented using a cloud-based approach. In other embodiments, publisher identification subsystem 1407 is implemented across one or more facilities, where each of the components are located in different facilities and interconnection 1533 is then a network-based connection. In further embodiments, publisher identification subsystem 1407 is implemented within a single server or computer. In yet other embodiments, publisher identification subsystem 1407 is implemented in software. In other embodiments, publisher identification subsystem 1407 is implemented using a combination of software and hardware. In yet other embodiments, publisher identification subsystem 1407 is hosted by a cloud services provider such as AMAZON® Web Services.

Databases 1532 stores information and data for use by publisher identification subsystem 1407. This includes, for example:
one or more algorithms and programs necessary to perform AI and ML-related operations and other operations, and
data needed for predictive processing subsystems 1530-1 to 1530-N to perform operations and functions. This comprises, for example:
   data and metadata related to input requests submitted by advertisers,
   data and metadata related to advertisers which have registered with the publishing identification subsystem 1407, for example, advertiser profiles,
   data and metadata related to publishers which have registered with the publishing identification subsystem 1407, for example, publisher profiles,
   payment information,
   data related to previous campaigns connected with each advertiser,
   data related to previous campaigns connected with each publisher,
   search histories,
   previous search results, and
   product and shipping information.

In some embodiments, database 1532 further comprises a database server. The database server receives one or more commands from, for example, predictive processing subsystems 1530-1 to 1530-N and communication subsystem 1534, and translates these commands into appropriate database language commands to retrieve and store data into databases 1532. In one embodiment, database 1532 is implemented using one or more database languages known to those of skill in the art, including, for example, Structured Query Language (SQL). In a further embodiment, database 1532 stores data for a plurality of publishers and advertisers. Then, there may be a need to keep the set of data related to each publisher or advertiser separate from the data relating to the other publishers or advertisers. In some embodiments, database 1532 is partitioned so that data related to each publisher or advertiser is separate from the other publishers or advertisers. Then each publisher or advertiser needs to authenticate themselves so as to access information related to their particular data sets. In a further embodiment, when data is entered into databases 1532, associated metadata is added so as to make it more easily searchable. In a further embodiment, the associated metadata comprises one or more tags. In yet another embodiment, database 1532 presents an interface to enable the entering of search queries. Further details of this are explained below. In some embodiments databases 1532 comprises a transactional database. In other embodiments, databases 1532 comprise a multitenant database.

Third party systems 1408 are similar to third party systems 108, that is, they are systems owned by third party providers. These include, for example, systems to:
Track shipments of products,
Fulfil payments,
Enable live chats, and
Enable social media interaction.

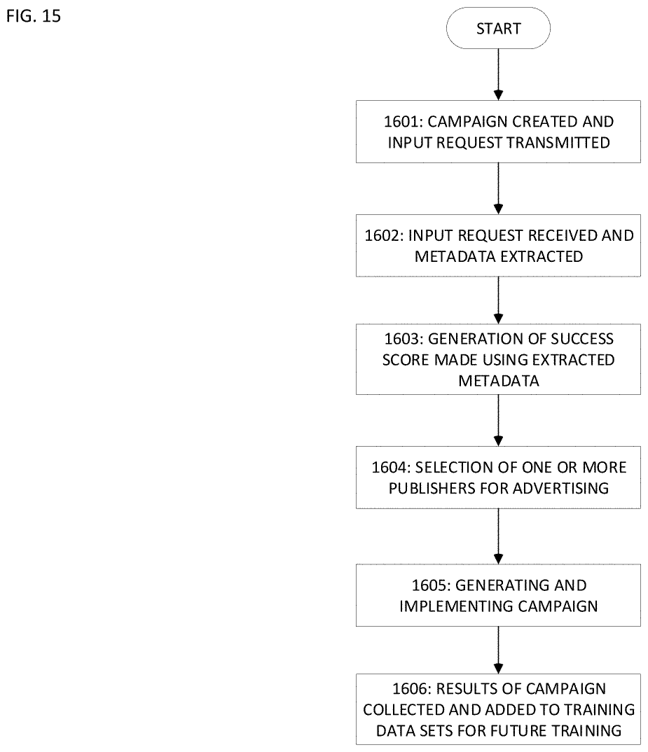

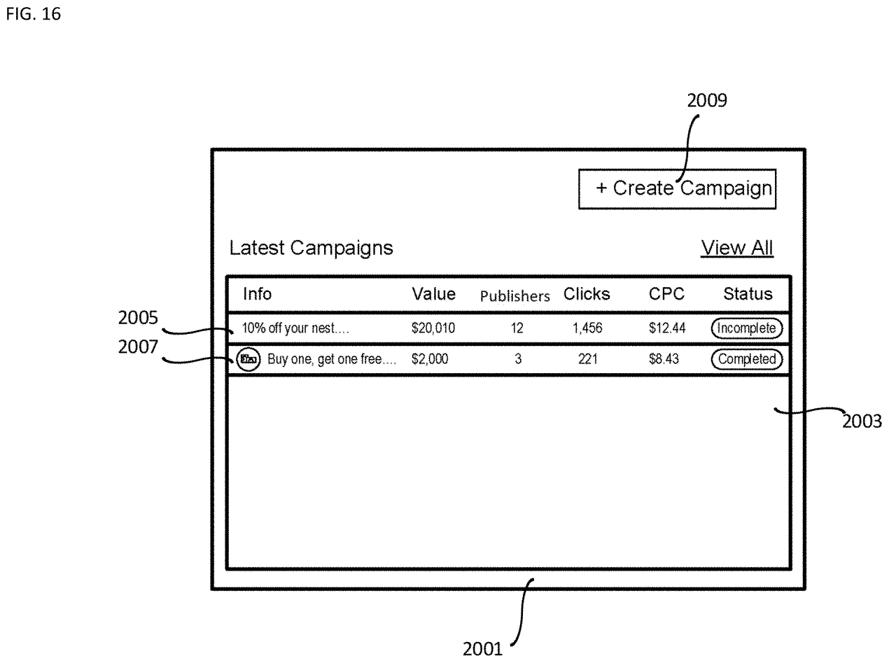

An example embodiment of a process for publisher identification is shown in FIG. 15. In some embodiments, the process is implemented by an offer bot which interacts with the advertiser via a series of user interfaces as shown in FIGS. 16, 17, and 19 — 22.

FIG. 16 shows an advertiser dashboard 2001 which is generated by the offer bot and transmitted from publisher identification subsystem 1407 to advertiser device 1404 via communications subsystem 1534 and network 1405. Advertiser dashboard 2001 is displayed on the screen of advertiser device 1404, and comprises table 2003 with the latest campaigns in rows 2005 and 2007. Each row comprises information about a campaign such as:
The value of the campaign,
The number of publishers the campaign is directed to,
The number of clicks received within the campaign,
The cost per click of the campaign, and
The status of the campaign, that is, whether it is incomplete or completed.

In step 1601, advertiser 1401 creates a new campaign by providing commands or inputs to advertiser dashboard 2001. These commands and inputs are provided by, for example, advertiser 1401 clicking button 2009 on the screen of advertiser device 1404.

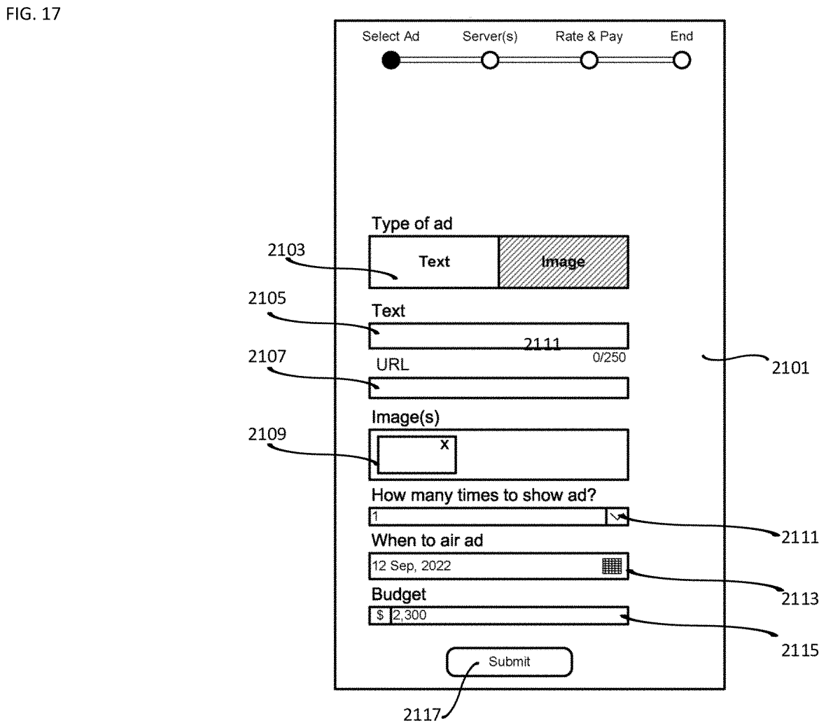

As part of step 1601, advertiser 1401 sends an input request to the offer bot residing in publisher identification subsystem 1407. In some embodiments, the input request is generated as follows: When the advertiser 1401 clicks button 2009 on advertiser dashboard 2001 on the screen of advertiser device 1404, a command is sent to the offer bot. In response, the offer bot generates an advertisement creation interface 2101, which is transmitted to advertiser device 1404 as part of outgoing signals 1560. An example embodiment of an advertisement creation interface 2101 is shown in FIG. 17. Advertiser 1401 inputs, via advertiser device 1404, information to generate the advertisement, including:
Button 2103 to select type of advertisement, for example, whether text or image;
Field 2105 to enter text for the advertisement when, for example, the advertisement is a text advertisement;
Field 2107 to enter a Uniform Resource Locator (URL) relevant to the advertisement;
Field 2109 to enter images for the advertisement when, for example, the advertisement is an image advertisement;
Field 2111 to enter the number of times to show the advertisement;
Field 2113 showing the begin date of the advertisement;
Field 2115 showing the budget for the advertisement.

In some embodiments, other information is provided to generate the advertisement, such as
Advertising category,
Advertising interests,
Advertising locations,
Advertising budget, and
Advertising success factor.

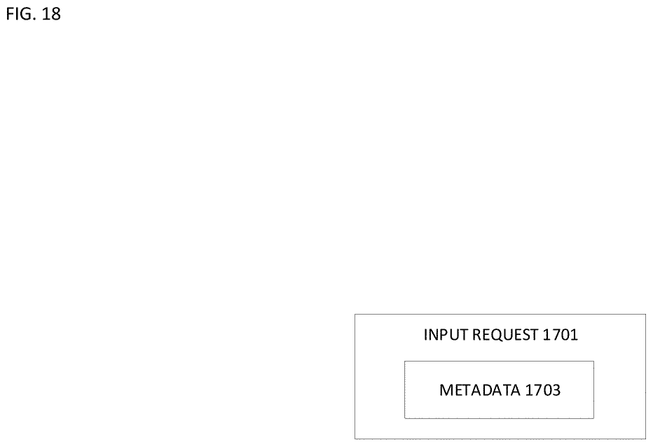

Once the advertiser 1401 has completed this, advertiser 1401 clicks on submit button 2117. An input request is created at advertiser device 1404 and transmitted to communications subsystem 1534 within incoming signals 1550 via network 1405. An embodiment of the input request is shown in FIG. 18. Input request 1701 comprises metadata 1703. Metadata 1703 comprises data about the input request 1701, and is based on the information provided by the advertiser 1401 to advertisement creation interface 2101.

In another example, an advertiser interacts with advertisement creation interface 2101 to create an input request having the following metadata:
Advertising category=“boots”,
Advertising interests=“hikers”,
Advertising locations=“mountainous areas”,
Advertising budget=$10,000;
Advertising success factor=“sales”,
Begin date of advertising campaign=“Sep. 1, 2022”, and
End date of advertising campaign=“Sep. 5, 2022”.

In step 1602, input request 1701 is received by predictive processing subsystems 1530-1 to 1530-N, where at least some portion of metadata 1703 is extracted and converted to an instance. In some embodiments, this conversion comprises, for example, pre-processing steps such as normalization. In some embodiments, step 1602 is performed by the offer bot.

In step 1603, based on the instance obtained in step 1602, predictive processing subsystems 1530-1 to 1530-N predicts the chances of success for each publisher stored within the publisher identification subsystem 1407. In some embodiments, step 1603 comprises generation of a conversion score or success score between 0 and 100 for each publisher for the instance.

One of skill in the art would appreciate that there are a variety of AI/ML algorithms and approaches which can be used to generate a conversion or success score. In some embodiments, one or more classification algorithms are used to generate a conversion or success score. Using one or more classification algorithms, each publisher is analyzed to identify one or more publishers which best suit the example instance.

One of skill in the art would recognize that different types of classification algorithms can be used to perform this step. Examples of such classification algorithms include but are not limited to:
k-nearest neighbours,
decision trees,
naïve Bayes,
random forest,
gradient boosting,
logistic regression,
support vector machine, and
neural networks.

One of skill in the art would also appreciate that the parameters of the one or more AI/ML algorithms used are determined through training and testing using one or more data sets comprising one or more previous results. Techniques for training and testing are well known and will not be discussed in detail here. Based on the outputs of the one or more AI/ML algorithms used, a success score is generated for each publisher.

An example embodiment is demonstrated below using the previously described metadata. The analysis to identify the best publisher comprises answering the following questions:
What publisher has users with that specific interest of hiking, AND
What publisher falls into the specific category of boots, AND
What publisher has access to users who belong to areas with mountains, AND
What publisher is available within that timeline, AND
What publishers are successful at generating sales?Based on the answers to these questions, a success score is generated for each publisher.

In step 1604, based on the success scores generated in step 1603, predictive processing subsystems 1530-1 to 1530-N selects one or more publishers for advertising from publishers 1403. In some embodiments, the selection is based on a ranking of all publishers. For example, the publishers are ranked in descending order of score, and one or more publishers are selected based on the ranking. For example, each of the publishers in publishers 1403 are ranked in descending order based on the generated success score, and the top five (5) publishers are selected.

For example, for the submitted input request 1701, based on the process in steps 1601-1604, one or more publishers comprising one or more online communities such as DISCORD® servers, REDDIT® sub-forums, SLACK® channels and WHATSAPP® groups are selected.

In some embodiments, step 1604 comprises predictive processing subsystems 1530-1 to 1530-N calculating a portion of the advertising budget corresponding to each of the selected publishers based on the generated success score for each publisher. For example, the publisher with the highest score in the selection is awarded the largest portion of the advertising budget, the publisher with the second highest score is awarded the second largest portion, and so on. One of skill in the art would appreciate that there are various techniques to calculate the portion of the budget.

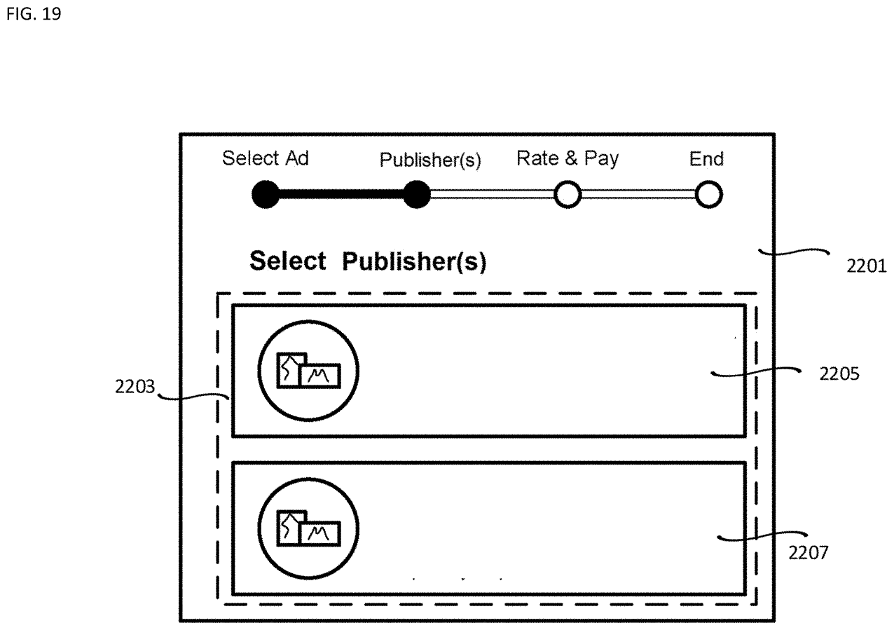

In some embodiments, as part of step 1604, the offer bot residing on predictive processing subsystems 1530-1 to 1530-N generates a selected publisher interface. An embodiment of a selected publisher interface 2201 is shown in FIG. 19. Selected publisher interface 2201 presents a list of selected publishers 2203 having publishers 2205 and 2207 to the advertiser 1401.

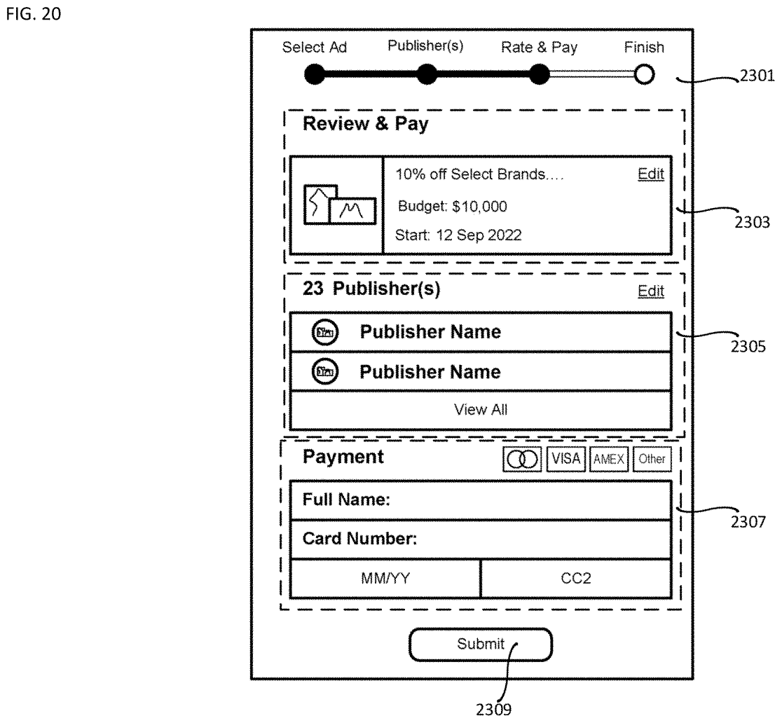

An example embodiment of a summary interface 2301 presented to advertiser device 1404 is shown in FIG. 20. Summary interface 2301 enables advertiser 1401 to
review the campaign in field 2303;
inspect the selected publishers in field 2305; and
pay for the campaign in field 2307.

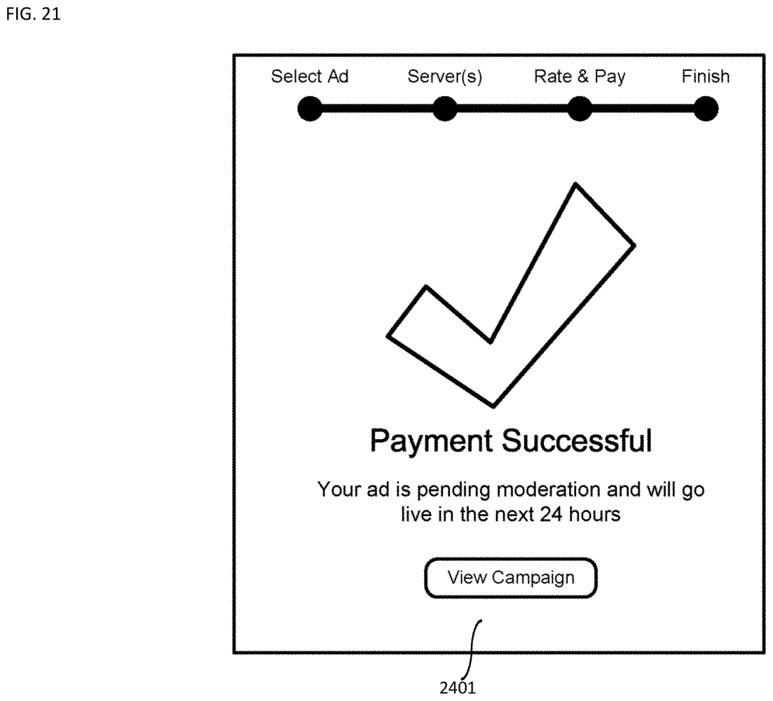

When advertiser 1401 clicks submit button 2309 and the campaign is successfully paid for, then a payment confirmation window is generated by the offer bot residing within publisher identification subsystem 1407 and transmitted to advertiser device 1404. An example embodiment of a payment confirmation window 2401 is shown in FIG. 21.

In step 1605, predictive processing subsystems 1530-1 to 1530-N generates and implements the campaign using the one or more publishers selected from publishers 1403. This comprises predictive processing subsystems 1530-1 to 1530-N interacting via network 1405 with the one or more publishers selected from publishers 1403. In some embodiments, the implementation of the campaign is based on the portions calculated in step 1604. In some embodiments, predictive processing subsystems 1530-1 to 1530-N generates and implements the campaigns using the previously mentioned offer bot.

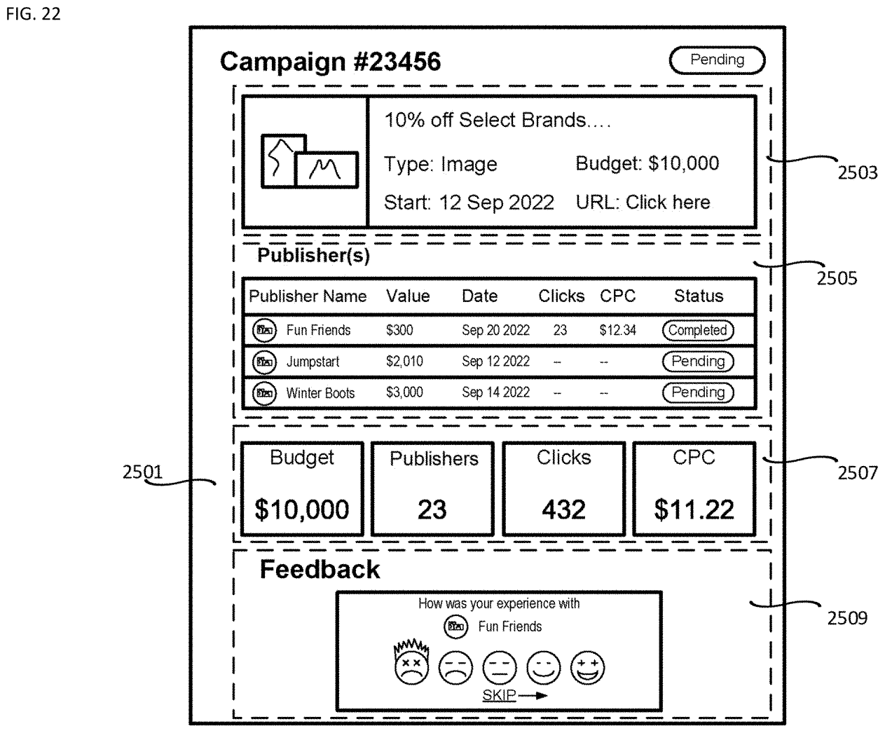

In some embodiments, as part of step 1605 the advertiser 1401 is able to view a campaign dashboard generated by the offer bot. An example embodiment of a campaign dashboard 2501 is shown in FIG. 22. Campaign dashboard 2501 shows information relevant to a specific campaign, and enables advertiser 1401 to submit further inputs, for example:
Advertisement 2503;
Value, date, clicks, cost-per-click (CPC) and status for each publisher as shown in table 2505;
An overview 2507; and
Feedback 2509.

Results from advertiser 1401 interaction with campaign dashboard 2501 are transmitted to publisher identification subsystem 1407 via networks 1405.

In step 1606, the results of the campaign are transmitted from the one or more selected publishers to predictive processing subsystems 1530-1 to 1530-N. In some embodiments, this information is presented to advertiser 1401 by the offer bot via one or more of the previously described dashboards and advertiser device 1404. The results are collected by predictive processing subsystems 1530-1 to 1530-N and are also added to the data sets for further training and testing of the AI/ML algorithms by predictive processing subsystems 1530-1 to 1530-N.

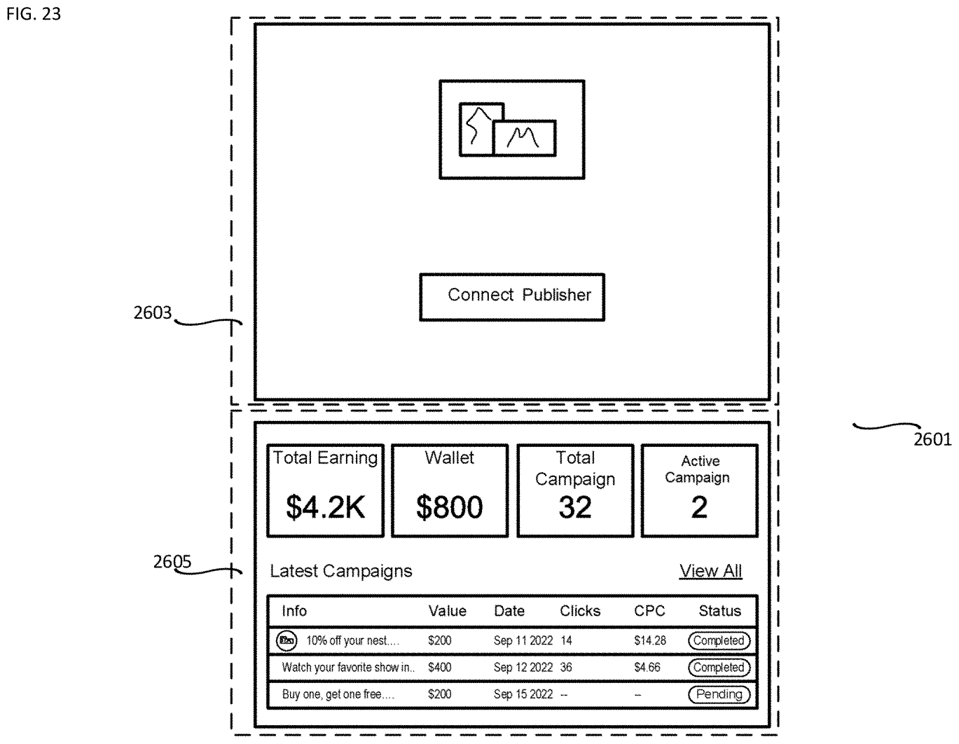

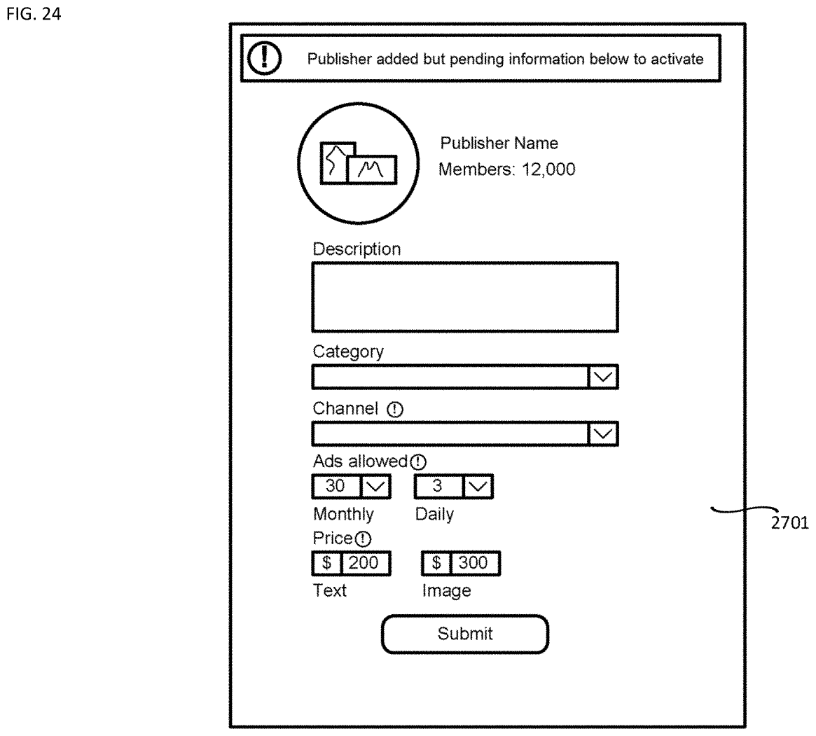

In further embodiments, the offer bot also communicates with the publishers 1403 to present various interfaces and dashboards. Example embodiments of a publisher dashboard are shown in FIGS. 23 and 24.

In FIG. 23, dashboard 2601 enables an owner of a publisher to connect in element 2603. Element 2605 allows the owner of the publisher to view various information related to active and previous campaigns, including data such as total earnings, total campaigns and active campaigns.

In FIG. 24, dashboard 2701 enables the owner of the publisher to provide information after the publisher has been added. The dashboard allows the owner to add publisher parameters such as:
publisher name,
publisher description,
publisher category,
publisher channel,
number of advertisements allowed in the publisher, and
prices of text and image advertisements.

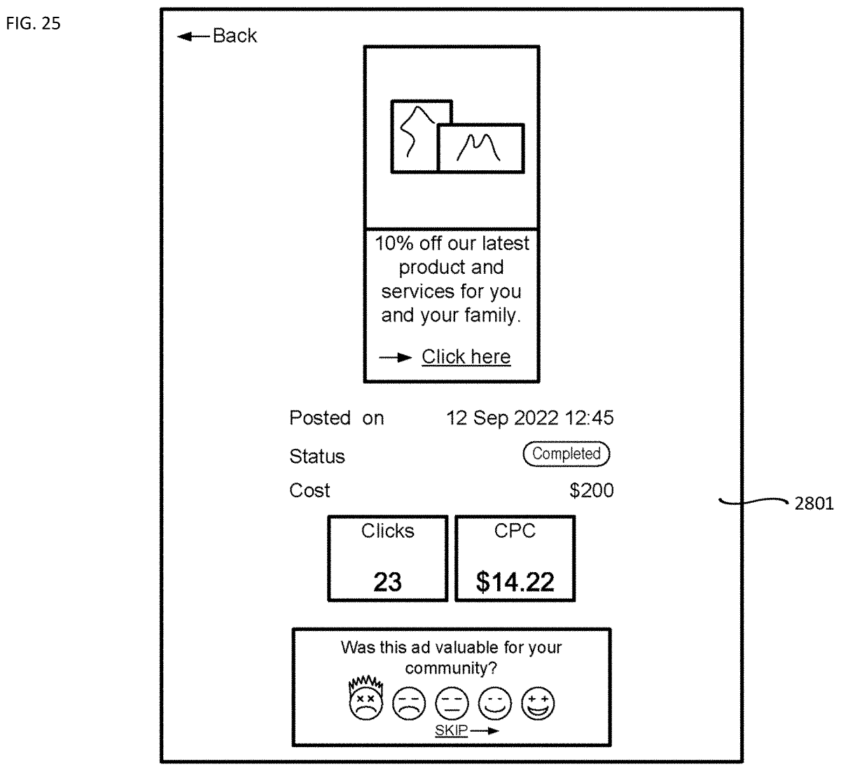

FIG. 25 provides a dashboard 2801 to enable an owner of a publisher to view data related to a specific campaign being run within the publisher.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A system for determining one or more publishers for an advertising campaign comprising
a publisher identification subsystem, wherein
the publisher identification subsystem is communicatively coupled to an advertiser device and a plurality of publishers via a network, further wherein
the publisher identification subsystem comprises a communications subsystem, a database and one or more predictive processing subsystems coupled to each other via an interconnection,
the communications subsystem receives one or more incoming signals from the network, and
the communications subsystem transmits one or more outgoing signals to the network;
the one or more incoming signals comprises an input request transmitted by the advertiser device, wherein the input request comprises a set of metadata;
the input request is received by the communications subsystem and sent to the one or more predictive processing subsystems;
the set of metadata is extracted by the one or more predictive processing subsystems;
the one or more predictive processing subsystems generates a plurality of success scores based on the extracted set of metadata, wherein
the plurality of success scores is generated using at least one artificial intelligence (AI) or machine learning (ML) algorithm,
one or more parameters of the at least one AI or ML algorithm are determined via training and testing, further wherein
the training and testing are performed using one or more data sets comprising one or more previous results, and
each of the plurality of success scores corresponds to one of the plurality of publishers;
the one or more predictive processing subsystems selects the one or more publishers from the plurality of publishers based on the one or more success scores;
the one or more predictive processing subsystems implements the advertising campaign using the selected one or more publishers; and
one or more results of the advertising campaign are collected and added to the one or more data sets comprising one or more previous results.

2. The system of claim 1, wherein
the metadata comprises a budget; and
one or more portions of the budget are allocated to the selected one or more publishers based on the one or more success scores.

3. The system of claim 1, wherein the selected one or more publishers comprise one or more online communities.

4. The system of claim 1, wherein the at least one AI or ML algorithm comprises at least one classification algorithm.

5. The system of claim 3, wherein the one or more online communities are related to at least one of
an instant messaging application;
a social media network; and
an online forum.

6. The system of claim 1, wherein
an offer bot is implemented by the one or more predictive processing subsystems;
the offer bot generates an advertisement creation interface;
the communications subsystem transmits the advertisement creation interface to the advertiser device as part of the one or more outgoing signals; and
the advertiser device transmits the input request using the advertisement creation interface.

7. The system of claim 6, wherein the offer bot generates the one or more success scores.

8. A method for determining one or more publishers for an advertising campaign comprising
receiving, by a publisher identification subsystem, one or more signals comprising an input request, wherein
the input request comprises a set of metadata, and
the input request is transmitted by an advertiser device;
extracting, by the publisher identification subsystem, the set of metadata;
generating, by the publisher identification subsystem, a plurality of success scores based on the extracted set of metadata, wherein
the generating is performed using at least one artificial intelligence (AI) or machine learning (ML) algorithm,
one or more parameters of the at least one AI or ML algorithm are determined via training and testing, further wherein
the training and testing are performed using one or more data sets comprising one or more previous results, and
each of the plurality of success scores corresponds to one of the plurality of publishers;
selecting, by the publisher identification subsystem, the one or more publishers from a plurality of publishers based on the one or more success scores;
implementing, by the publisher identification subsystem, the advertising campaign using the selected one or more publishers;
collecting, by the publisher identification subsystem, one or more results of the advertising campaign; and
adding, by the publisher identification subsystem, the collected one or more results of the advertising campaign to the one or more data sets comprising one or more previous results.

9. The method of claim 8, wherein
the metadata comprises a budget; and
one or more portions of the budget are allocated to the selected one or more publishers based on the one or more success scores.

10. The method of claim 8, wherein the selected one or more publishers comprise one or more online communities.

11. The method of claim 8, wherein the at least one AI or ML algorithm comprises at least one classification algorithm.

12. The method of claim 10, wherein the one or more online communities are related to at least one of
an instant messaging application;
a social media network; and
an online forum.

13. The method of claim 8, further comprising
generating, by an offer bot, an advertisement creation interface; and
the advertiser device transmits the input request using the generated advertisement creation interface.

14. The method of claim 13, wherein the generating of the one or more success scores is performed by the offer bot.
